(19) United States
(12) Patent Application Publication
(10) Pub. No.: US 2018/0140993 A1
(43) Pub. Date: May 24, 2018

(54) COMBINED SYSTEM BASED ON MIXTURES OF IONIC LIQUIDS AND AMINO ACIDS TO ABSORB CARBON DIOXIDE

(71) Applicant: INSTITUTO MEXICANO DEL PETROLEO, Mexico City (MX)

(72) Inventors: Rafael MARTINEZ PALOU, Mexico City (MX); Javier GUZMAN PANTOJA, Mexico City (MX); Roberto GARCIA DE LEON, Mexico City (MX); Christian ORTEGA GUEVARA, Mexico City (MX)

(21) Appl. No.: 15/821,469

(22) Filed: Nov. 22, 2017

(30) Foreign Application Priority Data
Nov. 22, 2016 (MX) MX/A/2016/015269

(51) Int. Cl. B01D 53/14

(52) U.S. Cl. CPC B01D 53/1493; B01D 2252/30; B01D 2252/20494; B01D 53/1475

(57) ABSTRACT

The present invention describes a combined liquid absorbent system to capture gaseous CO₂. The said combination is given by the mixture of an IL and an amino acid aqueous solution. This mixture has an improved CO₂ absorption performance with respect to the separate components that are part of it. These components can be regenerated and reused in several absorption cycles without losing absorption capacity.

### TECHNICAL FIELD OF THE INVENTION

The present invention is related to the field of absorption of carbon dioxide (CO₂) in gas phase using liquid absorbent systems. Due to the nature of the components of the combined system of liquids used in the present invention, the process corresponds to chemisorption, which was evaluated at 30° C. and 3 atmospheres of the aforementioned gas. Of course, these conditions are not limiting.

### Background of the Invention

The separation of CO₂ from gas mixtures emitted from stationary sources has become crucial. For gas mixtures such as natural gas, shale gas and syngas, the elimination of CO₂ considerably improves the fuel properties of these blends; in addition, the combination of CO₂ with water is very corrosive for pipes and equipment for transportation and storage of these gases.

CO₂ emissions from the combustion of fossil fuels became a worldwide concern since their increase in the atmosphere is related to the world's growing demand for energy and at the same time, CO₂ is one of the gases that contribute to the greenhouse effect, which is responsible for global warming and climate change. Although the development of new energy sources with low emissions should be the long-term goal of our society, in the near future, the development of CO₂ capture with efficient storage and recycling technologies is probably the only available strategy to control the CO₂ level emitted into the atmosphere.

The use of technologies for the capture, storage and processing of CO₂ may provide a medium-term solution to mitigate environmental impacts and enable mankind to continue using natural resources that generate energy from fossil fuels, at least until renewable energy technologies are completely ready for large-scale use.

For the removal of CO₂ in gaseous-post-combustion streams, different technologies have been developed such as chemical absorption with amines and sodium hydroxide and physical absorption with solvents such as methanol, N-methylpyrrolidone, dimethyl ether and polyethylene glycol, however, all these processes have many operational problems such as corrosion, loss of solvents in vapor form and high toxicity, which require systems that operate at low temperatures and very high pressures.

In recent years, the use of novel ionic liquids (ILs) as solvents has been described. These ILs have low toxicity, do not cause corrosion problems and have vapor pressures close to zero, so no losses are generated by evaporation. For example, in the international patent application WO2014/178991, a mixture of ILs (ethyl tris (Propyl/butyl phosphonium) with other solvents such as N-methylpyrrolidone and propylene glycol dimethyl ether was used for the physical absorption of CO₂. These mixtures have improved the absorption of CO₂ in comparison with the physical absorption of other solvents.

In the international patent application WO2012/017183, a process for separating CO₂ from a gas mixture based on the chemical absorption with 1-ethyl-3-methylimidazolium [EMIM] or 1-propyl-3-methylimidazolium containing acetate as anion in admixture with guanidinium acetate or 1-butyl-3-methylimidazolium acetate was proposed.

On the other hand, the US patent US2011/0223084 describes a CO₂ capture process using ILs functionalized with sulfur. The international patent application WO2014/166781 A1 proposes a CO₂ capture process using ILs, which exhibits a phase change upon CO₂ absorption, and from which the gas can be released by heating and the absorbent can be regenerated in the same process.

As for the Chinese patent application CN104415642A, it describes a process with high performance of CO₂ capture using ILs with amino groups derived from amino acids such as lysine, serine, valine, glycine and arginine in admixtures with diethanolamine and water.

Similarly, patent applications EP2174700, CN102895844A, WO2014/166781, CN102527192A, CN104524297A, CN104418322A and CN10248911A disclose the use of other ILs for CO₂ capture meanwhile the Chinese patent application CN102531991A shows the invention of novel ILs with multiamine functionalized imidazole derivatives such as pyrrole, indole, carbazole, pyrazol, 1,2,4-1-H-triazole, 1-H-triazole, purine, piperidine, imidazoline and piperazine and their preparation method.

Amino acids have also been employed for this purpose, for example, in the international patent application WO2014/166781, a process of CO₂ capture is described using common solvents such as water and ethanol amino acids. Meanwhile application EP0671200 describes a CO₂ capture process from flue gas using a mixture of amino acid salts with piperazine and a copper compound dissolved in water.

As explained before and as far as known by the applicant, the present invention overcomes by far the references cited above by providing a combined CO₂ absorption system using amino acids dissolved in tetra methylammonium (TMA) ILs whose anions are derived from amino acids such as alanine (Ala), lysine (Lys) or glycine (Gly), for example.

Likewise, another objective of the present invention is to provide aqueous mixtures of ILs and amino acids with higher absorption capacity than their individual components.

### BRIEF DETAILED DESCRIPTION OF THE INVENTION SCHEMES

In order to clearly understand the combined system of CO₂ absorption using ILs and amino acids, which is the object of the present invention, the description of the figures featured in it is offered without limiting its scope:

FIG. 1 shows the diagram of the equipment used for the evaluation of CO₂ absorbents consisting of a gas cell (A), a thermostat (B), a manometer (C), a stainless steel reactor with magnetic stirring (D), a vacuum pump (E) and a stirring plate (F). The temperature was measured with a thermocouple placed in the water bath (uncertainty below ±0.1 K).

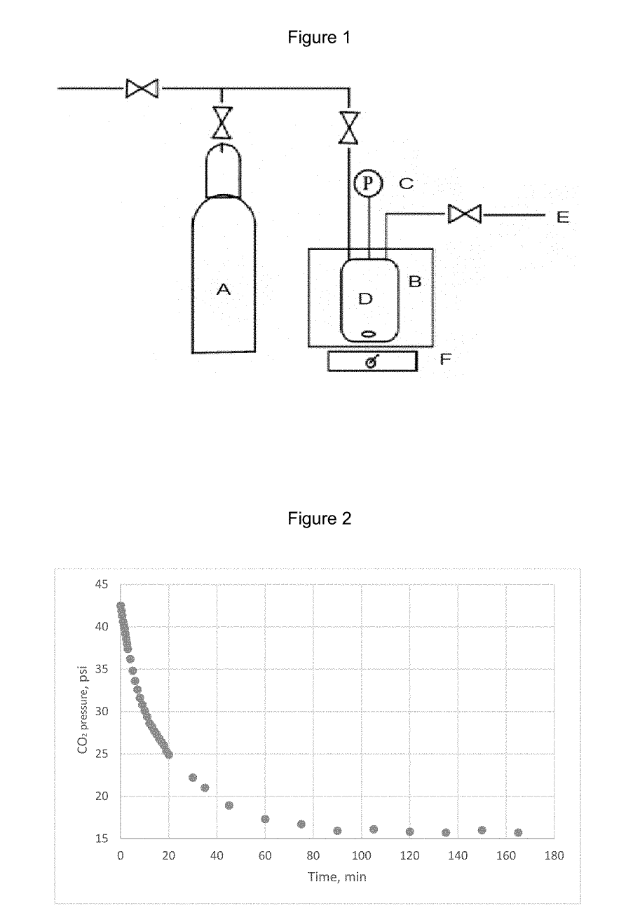

FIG. 2 presents the pressure behavior of CO₂ versus time for the lysinate tetramethyl ammonium+3% aqueous alanine system. The evaluation conditions were 3 atmospheres of CO₂ and 30° C. FIG. 2 describes the behavior of CO₂ absorption for the mixture of compounds described in Example 1.

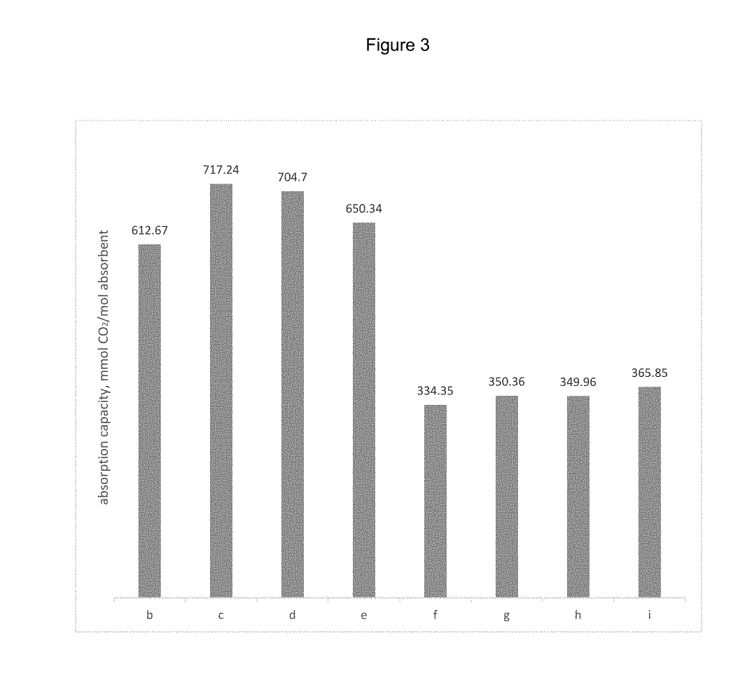

FIG. 3 exhibits the molar absorption capacity of CO₂ in the IL systems. The evaluation conditions were 3 atmospheres of CO₂ and 30° C.

### DETAILED DESCRIPTION OF THE INVENTION

The present invention is a novel application for CO₂ absorption from gaseous mixtures using a system of aqueous solutions of amino acids and ILs. In the best of our knowledge, these mixtures of components have not been reported for this application.

The preparation of the amino acid solutions using alanine, lysine and glycine is performed at 3 wt. % in distilled water meanwhile ILs based on tetramethylammonium are purified and until the time of use, they have no traces of residual solvents, which ensures that the CO₂ absorption is due solely to the amino acid and the corresponding IL aqueous solution.

The composition of the liquid system consists of 5 grams of pure tetramethylammonium glycinate or tetramethylammonium lysinate and 5 grams of aqueous IL, 3 wt. % of the corresponding amino acid. The evaluation conditions are 30° C. and 3 atmospheres of CO₂.

To measure the absorption capacity of a liquid system with respect to a gas (or gas mixture) under saturation conditions, a cell was designed and built to operate at constant volume and variable pressure, and to be immersed in a temperature-controlled bath. The cell is equipped with a magnetic stirrer. The previously described arrangement is called gas absorption system using liquid mixtures. Calculations are performed by using the ideal gas law.

Through the data collected from the pressure drop versus time experiment, keeping constant the temperature and amount of absorbent material, it is possible to know the amount of absorbed gas and thereby calculate the gas absorption capacity (CO₂ in the case of this invention) of the system conformed by the aqueous solution of amino acid and the corresponding IL under saturation conditions.

FIG. 2 presents the typical performance for CO₂ absorption using a liquid mixture of absorbent. The time in minutes is plotted on the horizontal axis and the pressure of the gas inside the cell is represented on the vertical axis. It is observed that as time passes by, the gas pressure tends to decrease to a constant value, which is the saturation pressure, and is the maximum level of absorbed CO₂ under the employed conditions.

FIG. 3 shows a comparison of the absorption capacity of the pure ILs lysinate tetramethylammonium (LysTMA) and glycinate tetramethylammonium (GlyTMA), and mixtures thereof with the amino acids lysine (Lys), alanine (Ala) or glycine (Gly) in aqueous solution (3 wt. %). This absorption capacity is expressed in millimoles of CO₂ per gram of absorbent. It is observed that the pure IL tetramethylammonium lysinate has a CO₂ absorption capacity that is lower than those the mixtures thereof with aqueous amino acid; the behavior displayed by tetramethylammonium glycinate (GlyTMA) is similar. Furthermore, it should be noted that the capacity of tetramethylammonium lysinate and its mixtures is almost twice the capacity of the respective glycinate.

Table 1 shows a comparison between the results of the present invention and those reported in the literature. It is observed that monoethanolamine (MEA) has an intermediate absorption capacity evidenced by the results achieved with ILs and their mixtures. However, it is noteworthy to emphasize that the conditions are not the same, e.g., the concentration reported for MEA is 30 wt. %, and in the case of the present invention is 3 wt. %, which makes evident that the system proposed here employs a lower solute concentration.

### EXAMPLES

Examples related to the combined liquid system for CO₂ absorption based on ILs and amino acids, which is the object of the present invention and described above, are presented without limiting its technical scope.

Here, the general experimentation procedures to evaluate each combined system comprising a mixture of IL and aqueous amino acid are disclosed. The total amount of liquid in the present examples is fixed at 10 grams of sample when used as pure IL, namely tetramethylammonium lysinate (LysTMA) and glycinate tetramethylammonium (GlyTMA), and in the case of mixtures, the system was conformed with 5 grams of pure IL and 5 grams of aqueous amino acid solution (3 wt. %).

The isotherms for CO₂ absorption were obtained at 303 K using an initial pressure of 3 atm FIG. 1 shows the diagram of the arrangement to carry out the experiments, which consists of a CO₂ gas cylinder (A), a thermostat (B), a manometer (C), a stainless steel reactor with magnetic stirring (D), a vacuum pump (E) and a stirring plate (F). The temperature was recorded with a thermometer placed in the heating bath (uncertainty below ±0.1 K).

### Example 1

Following the general experimentation procedure, the absorption of a tetramethyl ammonium lysinate+3% aqueous alanine mixture was measured. The evaluation conditions were 3 atmospheres of CO₂ and 30° C. In FIG. 1, the behavior of the pressure change versus time for this mixture is shown, where the CO₂ absorption was 717.24 mmol of CO₂/mol of absorbent.

### Example 2

Following the general experimentation procedure, the absorption of a tetramethyl ammonium lysinate+3% aqueous lysine mixture was measured. The evaluation conditions were 3 atmospheres of CO₂ and 30° C. The CO₂ absorption was 704.7 mmol of CO₂/mol of absorbent.

### Example 3

Following the general experimentation procedure, the absorption of a tetramethyl ammonium lysinate+3% aqueous glycine mixture was measured. The evaluation conditions were 3 atmospheres of CO₂ and 30° C. The CO₂ absorption was 650.34 mmol of CO₂/mol of absorbent.

### Example 4

Following the general experimentation procedure, the absorption of a tetramethyl ammonium glycinate+3% aqueous lysine mixture was measured. The evaluation conditions were 3 atmospheres of CO₂ and 30° C. The CO₂ absorption was 350.36 mmol of CO₂/mol of absorbent.

### Example 5

Following the general experimentation procedure, the absorption of a tetramethyl ammonium glycinate+3% alanine aqueous mixture was measured. The evaluation conditions were 3 atmospheres of CO₂ and 30° C. The CO₂ absorption was 349.96 mmol of CO₂/mol of absorbent.

### Example 6

Following the general experimentation procedure, the absorption of a tetramethyl ammonium glycinate+3% aqueous lysine mixture was measured. The evaluation conditions were 3 atmospheres of CO₂ and 30° C. The CO₂ absorption was 365.83 mmol of CO₂/mol of absorbent.

TABLE 1
Comparison of the CO₂ absorption capacity

| | | Absorption capacity, |
|---|---|---|
| Entry | Absorbent | mmol CO₂/mol absorbent |
| a | Mono ethanol amine, | 516 |
| | 30 wt. % in aqueous solution * | |
| b | LysTMA ^{Δ} | 612.67 |
| c | LysTMA + Ala | 717.24 |
| d | LysTMA + Lys | 704.70 |
| e | LysTMA + Gli | 650.34 |
| f | GlyTMA ^{Δ} | 334.35 |
| g | GlyTMA + Ala | 350.36 |
| h | GlyTMA + Lys | 349.96 |
| i | GlyTMA + Gly | 365.83 |

NOTES:
1. * Source: http://dx.doi.org/10.1155/2015/965015
2. ^{Δ} TMA and TMA Gly were evaluated as pure compounds (without dilution).
3. The mixtures were evaluated with the amino acid at 3 wt. % in aqueous solution.

1. A liquid system, comprising:
a mixture of ionized liquids, wherein an ionized liquid (IL) of the mixture of ionized liquids comprises a heterocyclic cation and an anion including a deprotonated amino acid, the heterocyclic cation being of a tetramethylammonium type and the deprotonated amino acid being of a lysinate type or a glycinate type; and
amino acids to absorb carbon dioxide, the amino acids comprise an amino acid aqueous solution (AA) in a ratio IL:AA de 5˜90%:90˜5%. AA from about 5:90% to about 90:5%, the AA being of an alanine type, a lysine type or a glycine type.

2. The liquid system in accordance with claim 1, further comprising a solvent that comprises water.

3. The liquid system in accordance with claim 1, wherein the heterocyclic cation comprises one of imidazolium, pirazolio, piridinio o pirrolidinio. pyrazolium, pyridinium or pyrrolidinium.

4. The liquid system in accordance with claim 1, wherein the IL comprises an acyclic cation of the ammonium type, phosphonium type, or sulfonium type.

5. The liquid system in accordance with claim 1, wherein the IL absorbs carbon dioxide at a pressure between about 0.5 atmospheres and 20 atmospheres and a temperature between about 20° C. and 100° C.

6. The liquid system in accordance with claim 1, wherein a concentration of products in the solvent range from about 1% to 50%.
